(19) United States
(12) Patent Application Publication
(10) Pub. No.: US 2017/0052920 A1
(43) Pub. Date: Feb. 23, 2017

(54) SYSTEMS AND METHODS FOR PROVIDING OPEN VPX SLOT PROFILE CONFIGURATIONS

(71) Applicant: Cornet Technology, Inc., Springfield, VA (US)

(72) Inventor: Brett Elms, Fayetteville, PA (US)

(73) Assignee: Cornet Technology, Inc., Springfield, VA (US)

(21) Appl. No.: 15/241,641

(22) Filed: Aug. 19, 2016

Related U.S. Application Data
(60) Provisional application No. 62/207,812, filed on Aug. 20, 2015.

(51) Int. Cl. G06F 13/40; G06F 9/445

(52) U.S. Cl. CPC G06F 13/4068; G06F 9/44505

(57) ABSTRACT

Various computing systems may benefit from appropriate configuration and/or adaptation. For example, various computing systems operating in accordance with Open VPX may benefit from systems and methods for providing Open VPX profile configurators. An apparatus can include a first interface configured to connect to a backplane operable according to an open VPX specification, wherein the backplane has a first profile. The apparatus can also include a second interface configured to connect to a module operable according to the open VPX specification, wherein the module has a second profile. The apparatus can further include circuitry configured to permit communication between the first interface and the second interface according to the open VPX specification. The circuitry can be configurable to adapt the module to communicate with the backplane when the first profile does not match the second profile.

### CROSS-REFERENCE TO RELATED APPLICATION

This application is related to and claims the benefit and priority of U.S. Provisional Patent Application No. 62/207,812, filed Aug. 20, 2015, the entirety of which is hereby incorporated herein by reference.

### BACKGROUND

Field

Various computing systems may benefit from appropriate configuration and/or adaptation. For example, various computing systems operating in accordance with Open VPX may benefit from systems and methods for providing Open VPX profile configurators.

Description of the Related Art

The Open VPX (VITA 65) specification, incorporated herein by reference in its entirety, defines the system level VPX interoperability for a multi-vendor, multi-module, integrated system environment. This specification also defines the interconnectivity between modules and modules to the backplane, among other things Open VPX provides a descriptive language for identifying module requirements and backplane capability. This specification also provides, with the part number configuration, more information on the control and fabric planes, including the signal speeds.

FIG. 1 illustrates Open VPX interfaces and nomenclatures. As shown in the top center, a standard set of nomenclature can be used to describe the profile of an interface. At bottom center, a 3 U format blade is shown, although 6 U is also possible. The left and right sides show standardized pin configurations. As can be seen, however, numerous sections are specified as “user defined.”

There are three types of profiles defined in Open VPX: slot, module, and backplane. Most typical Open VPX backplanes may include a control plane, a management plane, a data plane, an expansion plane and a utility/power plane. Each of these planes, with the exception of the utility/power plane, may include pipes for slot-to-slot and module-to-module communication. An ultra-thin pipe may comprise at least one transmit and at least one receive pair of lines. A thin pipe may comprise two ultra-thin pipes and a fat pipe may comprise two thin pipes. Once a backplane is designed with the desired connectivity and manufactured, one way a company's module would plug into this slot is if the profiles match. This makes it difficult to interchange modules after the initial selection criteria are completed, even if short comings are identified.

### SUMMARY

An apparatus, according to certain embodiments, can include a first interface configured to connect to a backplane operable according to an open VPX specification, wherein the backplane has a first profile. The apparatus can also include a second interface configured to connect to a module operable according to the open VPX specification, wherein the module has a second profile. The apparatus can further include circuitry configured to permit communication between the first interface and the second interface according to the open VPX specification. The circuitry can be configurable to adapt the module to communicate with the backplane when the first profile does not match the second profile.

An apparatus, in certain embodiments, can include means for connecting to a backplane operable according to an open VPX specification, wherein the backplane has a first profile. The apparatus can also include means for connecting to a module operable according to the open VPX specification, wherein the module has a second profile. The apparatus can further include means for permitting communication between the first interface and the second interface according to the open VPX specification. The means for permitting communication comprises means for adapting the module to communicate with the backplane when the first profile does not match the second profile.

According to certain embodiments, a method can include connecting to a backplane operable according to an open VPX specification, wherein the backplane has a first profile. The method can also include connecting to a module operable according to the open VPX specification, wherein the module has a second profile. The method can further include permitting communication between the first interface and the second interface according to the open VPX specification. The permitting communication can include adapting the module to communicate with the backplane when the first profile does not match the second profile.

### BRIEF DESCRIPTION OF THE DRAWINGS

For proper understanding of the invention, reference should be made to the accompanying drawings, wherein:

FIG. 1 illustrates Open VPX interfaces and nomenclatures.

FIG. 2 illustrates a system according to certain embodiments.

FIG. 3 illustrates a method according to certain embodiments.

### DETAILED DESCRIPTION

Systems and methods of the present invention may initially concern the backplane profile. As mentioned above, once a backplane is designed with the desired connectivity and manufactured, one way a company's module would plug into this slot is if the profiles match. This may restrict interchange of modules after the initial selection criteria are completed, even if shortcomings are identified.

Certain embodiments of the present invention, for example various systems and methods, can provide Open VPX Slot Profile devices, such as what will be referred to as configurators, that may eliminate or mitigate this restriction.

An Open VPX Slot Profile configurator or similar device may comprise a small board that may reside between the Open VPX module and the backplane. The size and construction of the board may vary. Any desired physical arrangement of an adapter can be used as a configurator.

For example, the device can be configured such that a user can plug a module into an Open VPX Slot Configurator to provide a modified module. The resulting modified module can be inserted into the backplane. For example, the resulting modified module can be module in combination with an adaptor.

The Open VPX Slot Profile Configurator or other adaptor may connect the various planes from the modules to the backplane through a configuration mechanism comprising of shunts, switches, FPGA logic or the like.

The adaptor, for example, the Open VPX Slot Profile Configurator, may itself be configurable via a variety of mechanisms. For example, the adaptor can include one or more jumpers that can be installed and/or moved by a user to select a particular configuration for the adaptor. Likewise, the adaptor can include one or more physical toggle switches or other selectors that can be used to select a particular configuration for the adaptor. Alternatively, the adaptor can be configurable via communication with the backplane. Thus, a user may electrically reconfigure the adaptor using a communication protocol over the backplane. Similarly, the adaptor can be provided with another interface such as a universal serial bus (USB), Ethernet port, or other wired interface, or Bluetooth, WiFi, or other wireless interface. These interfaces in addition to the interface with the module(s) and backplane can be referred to as side interfaces. The adaptor can be configured to be reconfigurable over the side interfaces, such as by using a communication protocol.

These and other selection mechanisms can be used in combination with one another. For example, the adaptor can include a jumper that must be removed or installed in order for the side interfaces to be operable. This may help to limit unauthorized reconfiguration of the adaptor.

Although the use of FPGA logic and switches or the like may provide the added benefit of reconfiguration in the field, for secure applications, use of permanent shunts may be desired. This may eliminate the risk of someone reconfiguring the unit in the field, such as in a case where the backplane is segregated into secure enclaves at different levels.

For military applications, the configurator can be built with traces that can be cut during system integration for added security. This may ensure that once the system is deployed, the security will never be compromised inadvertently or intentionally. The same principle can be employed during module design. This may allow the manufactures to select the slot profile at manufacturing time and can reduce the need for redesign.

These permanent adaptations, such as permanent shunts can be used in combination with the selection mechanisms mentioned above. For example, the use of these adaptations may limit the adaptor to manual reconfigurations only, or to secure wired reconfigurations only. Similarly, the selection mechanisms can be used to limit the reconfigurations to a range of acceptable reconfigurations, and can be prevented from reconfiguring arbitrarily.

The adaptor can be provided with a private key so that the module and/or the backplane can confirm that the adaptor is an authorized part. The adaptor can be configured to monitor reconfigurations and to report the reconfigurations when queried. The adaptor can, for example, provide a hash of a reconfiguration file indicative of the current settings.

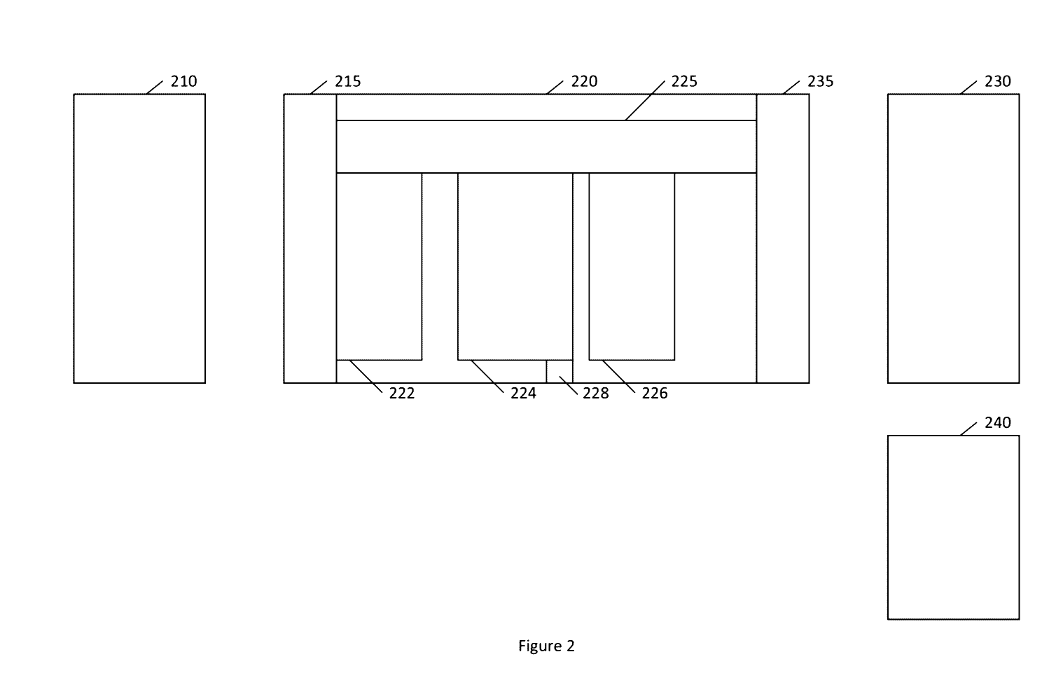

FIG. 2 illustrates a system according to certain embodiments of the present invention. The features of FIG. 2 are not to scale. As shown in FIG. 2, a system can include a backplane 210, an adapter 220, and a module 230.

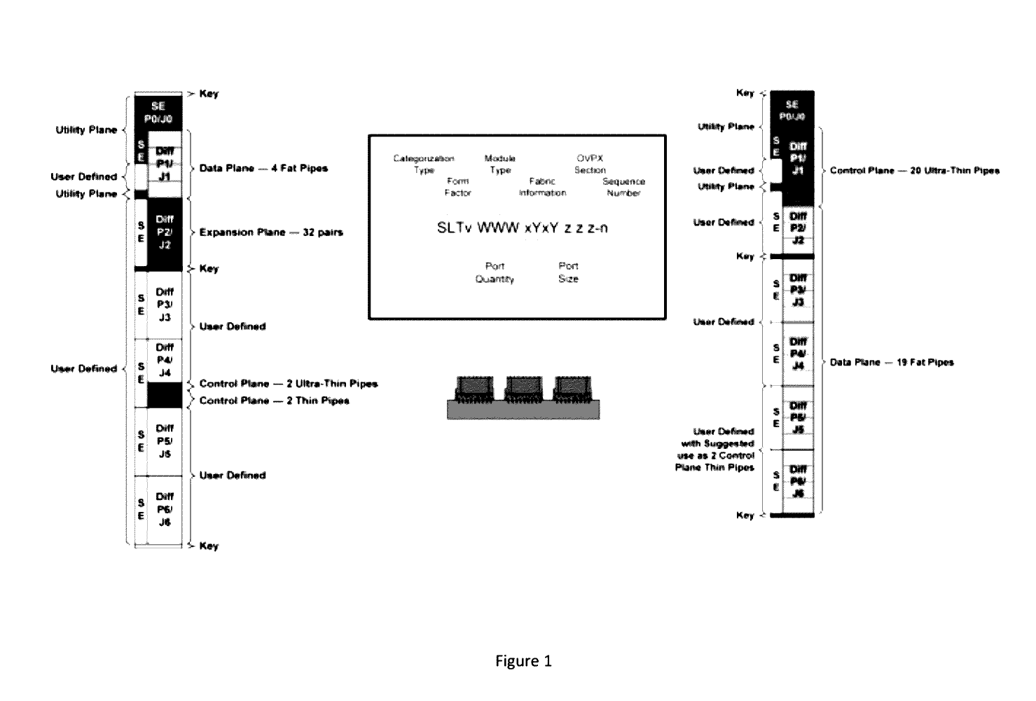

The adapter 220 can include a first interface 215 configured to connect to the backplane 210. Both the first interface 215 and the backplane 210 can be operable according to an open VPX specification. The backplane 210 can have a first profile defined, for example, as shown in FIG. 1.

The adapter 220 can also include a second interface 235 configured to connect to the module 230. Both the second interface 235 and the module 230 can also be operable according to the open VPX specification. The module 230 can have a second profile also defined, for example, as shown in FIG. 1.

The adapter 220 can also include circuitry 225 configured to permit communication between the first interface 215 and the second 235 interface according to the open VPX specification. The circuitry 225 can be configurable to adapt the module 230 to communicate with the backplane 210 even when the first profile does not match the second profile.

For example, a user defined portion of the first profile can differ from a corresponding user defined portion of the second profile. Thus, the circuitry 225 is reconfigurable to adapt a second module 240 having a third profile different from the second profile.

The circuitry 225 can be reconfigurable to adapt to operation on a plurality of networks having different security classifications (for example, secret, unclassified, and top secret).

The adapter 220 can also include communications hardware 222 configured to permit reconfiguration of the circuitry over the backplane. Alternatively, or in addition, the adapter 220 can further include a wired side interface 224 configured to permit reconfiguration of the circuitry without communication over the backplane. The wired side interface 224 can include a port 228. The port can include, for example, a serial port, an Ethernet port, or a universal serial bus port.

Alternatively, or in addition, the adapter 220 can also include a wireless side interface 226 configured to permit reconfiguration of the circuitry without communication over the backplane. The wireless side interface 226 can include a wireless port such as Bluetooth, infrared, or WiFi port.

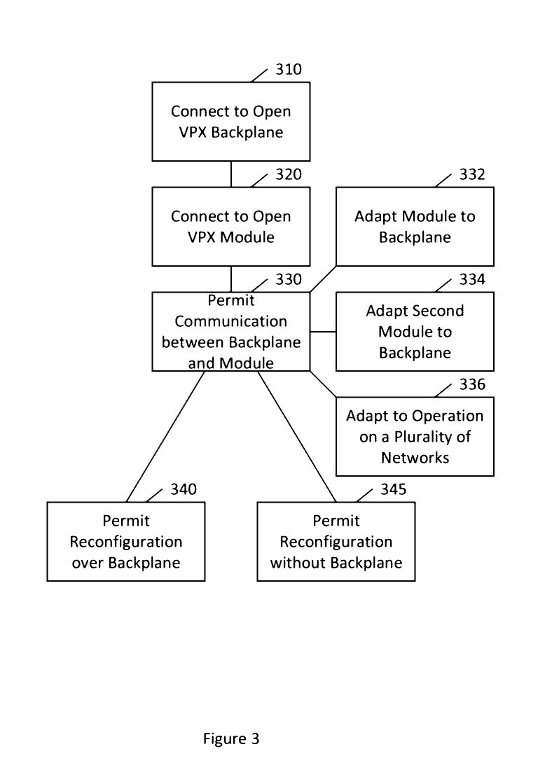

FIG. 3 illustrates a method according to certain embodiments. As shown in FIG. 3, a method can include, at 310, connecting to a backplane operable according to an open VPX specification, wherein the backplane has a first profile. The method can also include, at 320, connecting to a module operable according to the open VPX specification, wherein the module has a second profile. The method can further include, at 330, permitting communication between the first interface and the second interface according to the open VPX specification. Permitting communication can include, at 332, adapting the module to communicate with the backplane when the first profile does not match the second profile. A user defined portion of the first profile can differ from a corresponding user defined portion of the second profile.

The method can also include, at 334, adapting a second module having a third profile different from the second profile. Moreover, the method can include, at 336, adapting to operation on a plurality of networks having different classifications.

The method can further include, at 340, permitting reconfiguration of the circuitry over the backplane. The method can additionally include, at 345, permitting reconfiguration of the circuitry without communication over the backplane.

The order of operations shown in FIG. 3 is simply one example. The same steps may be performed in another order, if desired. The operations of FIG. 3 may be performed by, for example, using the adapter apparatus shown in FIG. 2.

The various blocks of FIG. 3 may be performed by a variety of different hardware configurations, which may also optionally include software. FIG. 2 illustrates some examples of possible hardware configurations. Other adapters configured to work with the Open VPX standard are also permitted.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. An apparatus, comprising:
a first interface configured to connect to a backplane operable according to an open VPX specification, wherein the backplane has a first profile;
a second interface configured to connect to a module operable according to the open VPX specification, wherein the module has a second profile; and
circuitry configured to permit communication between the first interface and the second interface according to the open VPX specification,
wherein the circuitry is configurable to adapt the module to communicate with the backplane when the first profile does not match the second profile.

2. The apparatus of claim 1, wherein a user defined portion of the first profile differs from a corresponding user defined portion of the second profile.

3. The apparatus of claim 1, wherein the circuitry is reconfigurable to adapt a second module having a third profile different from the second profile.

4. The apparatus of claim 1, wherein the circuitry is reconfigurable to adapt to operation on a plurality of networks having different classifications.

5. The apparatus of claim 1, further comprising:
communications hardware configured to permit reconfiguration of the circuitry over the backplane.

6. The apparatus of claim 1, further comprising:
a wireless side interface configured to permit reconfiguration of the circuitry without communication over the backplane.

7. The apparatus of claim 1, further comprising:
a wired side interface configured to permit reconfiguration of the circuitry without communication over the backplane.

8. The apparatus of claim 7, wherein the wired side interface comprises a port selected from at least one a serial port, an Ethernet port, or a universal serial bus port.

9. An apparatus, comprising:
means for connecting to a backplane operable according to an open VPX specification, wherein the backplane has a first profile;
means for connecting to a module operable according to the open VPX specification, wherein the module has a second profile; and
means for permitting communication between the first interface and the second interface according to the open VPX specification,
wherein the means for permitting communication comprises means for adapting the module to communicate with the backplane when the first profile does not match the second profile.

10. The apparatus of claim 9, wherein a user defined portion of the first profile differs from a corresponding user defined portion of the second profile.

11. The apparatus of claim 9, further comprising:
means for adapting a second module having a third profile different from the second profile.

12. The apparatus of claim 9, further comprising:
means for adapting to operation on a plurality of networks having different classifications.

13. The apparatus of claim 9, further comprising:
means for permitting reconfiguration of the circuitry over the backplane.

14. The apparatus of claim 9, further comprising:
means for permitting reconfiguration of the circuitry without communication over the backplane.

15. An method, comprising:
connecting to a backplane operable according to an open VPX specification, wherein the backplane has a first profile;
connecting to a module operable according to the open VPX specification, wherein the module has a second profile; and
permitting communication between the first interface and the second interface according to the open VPX specification,
wherein the permitting communication comprises adapting the module to communicate with the backplane when the first profile does not match the second profile.

16. The method of claim 15, wherein a user defined portion of the first profile differs from a corresponding user defined portion of the second profile.

17. The method of claim 15, further comprising:
adapting a second module having a third profile different from the second profile.

18. The method of claim 15, further comprising:
adapting to operation on a plurality of networks having different classifications.

19. The method of claim 15, further comprising:
permitting reconfiguration of the circuitry over the backplane.

20. The method of claim 15, further comprising:
permitting reconfiguration of the circuitry without communication over the backplane.
